(19) United States
(12) Patent Application Publication
(10) Pub. No.: US 2017/0344286 A1
(43) Pub. Date: Nov. 30, 2017

(54) SOLID STATE DRIVE DUPLICATION APPARATUS

(71) Applicant: CHAIN-IN ELECTRONIC CO., LTD., New Taipei City (TW)

(72) Inventor: Hong-Chuan WANG, New Taipei City (TW)

(21) Appl. No.: 15/287,659

(22) Filed: Oct. 6, 2016

(30) Foreign Application Priority Data
May 30, 2016 (TW) 105208056

(51) Int. Cl. G06F 3/06; G06F 13/42; G06F 13/40

(52) U.S. Cl. CPC G06F 3/0619; G06F 13/4068; G06F 13/4282; G06F 3/065; G06F 3/0688; G06F 2213/0026

(57) ABSTRACT

A solid state drive duplication apparatus having a plurality of duplication units, each of the duplication units including: a chain connection input port, a chain connection output port, a PCI-E interface, and a printed circuit board including an FPGA chip, wherein the duplication units are interconnected one another in a way that the chain connection output port of one unit of the duplication units is electrically connected with the chain connection input port of another unit of the duplication units; when in operation, a first unit of the duplication units outputs source data via the chain connection output port thereof, and each of other units of the duplication units uses the chain connection input port thereof to receive the source data and copy the source data into a solid state drive connected with the PCI-E interface thereof, and sends out the source data via the chain connection output port thereof.

### BACKGROUND OF THE INVENTION

### Field of the Invention

The present invention relates to a solid state drive duplication apparatus, especially to a PCI-E solid state drive duplication apparatus capable of expanding duplication capacity.

### Description of the Related Art

Conventional PCI-E (peripheral component interconnection-express) solid state drive duplication is performed by using a PCI-E connecting interface of a PCI-E control card of a PC (personal computer). However, it requires a platform provided by an OS (operating system) software program, and cannot process large number of solid state drives at a time.

Besides, to meet clients' different requirements of different number of PCI-E solid state drives to be processed at a time, the PCI-E solid state drive duplication apparatus manufacturers may have to prepare different specs. However, to meet the requirements of a variety of specs, the manufacturing cost will increase substantially.

Besides, when the PCI-E control card malfunctions, the whole PCI-E connecting interfaces thereof can be completely out of service.

To solve the foregoing problem, a novel PCI-E solid state drive duplication apparatus is needed.

### SUMMARY OF THE INVENTION

One objective of the present invention is to disclose a PCI-E solid state drive duplication apparatus, which uses FPGAs (field programmable gate array) to implement a PCI-E solid state drive duplication function, so as to independently perform a duplication operation without the need of PC's support, and have the PCI-E solid state drive duplication function implemented in a more simplified way than the way used in a conventional PCI-E controller.

Another objective of the present invention is to disclose a PCI-E solid state drive duplication apparatus, which can expand duplication capacity by chain connection to easily meet different specs requirements of processing different numbers of solid state drives at a time.

Another objective of the present invention is to disclose a PCI-E solid state drive duplication apparatus, where source data for duplication can be provided by an external computer, or by a solid state drive engaged with a first duplication unit, or by a storage medium of the solid state drive duplication apparatus.

Still another objective of the present invention is to disclose a PCI-E solid state drive duplication apparatus, which is implemented with a plurality of independently replaceable duplication units to facilitate fixing local malfunctions of the PCI-E solid state drive duplication apparatus.

Still another objective of the present invention is to disclose a PCI-E solid state drive duplication apparatus, which is capable of comparing the contents of a source PCI-E solid state drive with the contents of cloned PCI-E solid state drives to ensure the accuracy of duplication.

To attain the foregoing objectives, a solid state drive duplication apparatus having a plurality of duplication units is proposed, each of the duplication units comprising:

a chain connection input port;

a chain connection output port;

a PCI-E interface, and

a printed circuit board, which includes an FPGA chip, a chain connection interface, and a PCI-E interface circuit, the chain connection interface and the PCI-E interface circuit being electrically coupled with the FPGA chip;

wherein the duplication units are interconnected one another in a way that the chain connection output port of one unit of the duplication units is electrically connected with the chain connection input port of another unit of the duplication units; for each unit of the duplication units, the FPGA chip is electrically coupled with the chain connection input port and the chain connection output port via the chain connection interface, and electrically coupled with the PCI-E interface via the PCI-E interface circuit; and in a first unit of the duplication units, the FPGA chip controls to output source data via the chain connection output port; and in each of other units of the duplication units, the FPGA chip controls to receive the source data via the chain connection input port and copy the source data into a solid state drive connected with the PCI-E interface, and send out the source data via the chain connection output port.

In one embodiment, the source data is from a source solid state drive connected with the first duplication unit.

In one embodiment, the source data is derived by decompressing an image file from an external computer, and the external computer transmits the image file to the solid state drive duplication apparatus via a USB (universal serial bus) interface.

In one embodiment, the source data is derived by decompressing a source image file selected from a plurality of image files stored in a storage medium of the solid state drive duplication apparatus.

In one embodiment, the solid state drive duplication apparatus further includes an information display screen coupled with a display interface of the first duplication unit.

In one embodiment, the solid state drive duplication apparatus further includes multiple selection buttons coupled with a button circuit of the first duplication unit.

In one embodiment, each of the duplication units further includes a driving circuit for driving multiple light indicators.

In one embodiment, the solid state drive duplication apparatus further includes at least one PCI-E to SATA (serial advanced technology attachment) converting seat for accommodating at least one SATA solid state drive.

In one embodiment, the solid state drive duplication apparatus further includes an extension input port and an extension output port on a case.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 illustrates an outline of a solid state drive duplication apparatus according to an embodiment of the present invention.

FIG. 2 illustrates an exploded view of a duplication unit of the solid state drive duplication apparatus of FIG. 1.

FIG. 3 illustrates how duplication units of the solid state drive duplication apparatus of FIG. 1 are interconnected.

FIG. 4 illustrates a block diagram of a circuit implemented on a printed circuit board of the solid state drive duplication apparatus of FIG. 1.

FIG. 5 illustrates an operation scenario of a solid state drive duplication apparatus of the present invention.

### DETAILED DESCRIPTION OF THE PREFERRED EMBODIMENTS

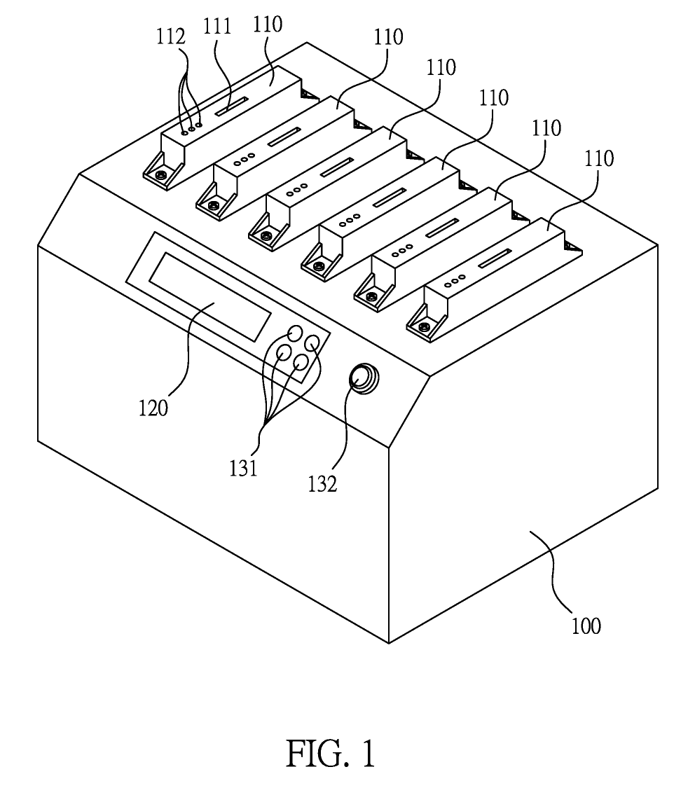

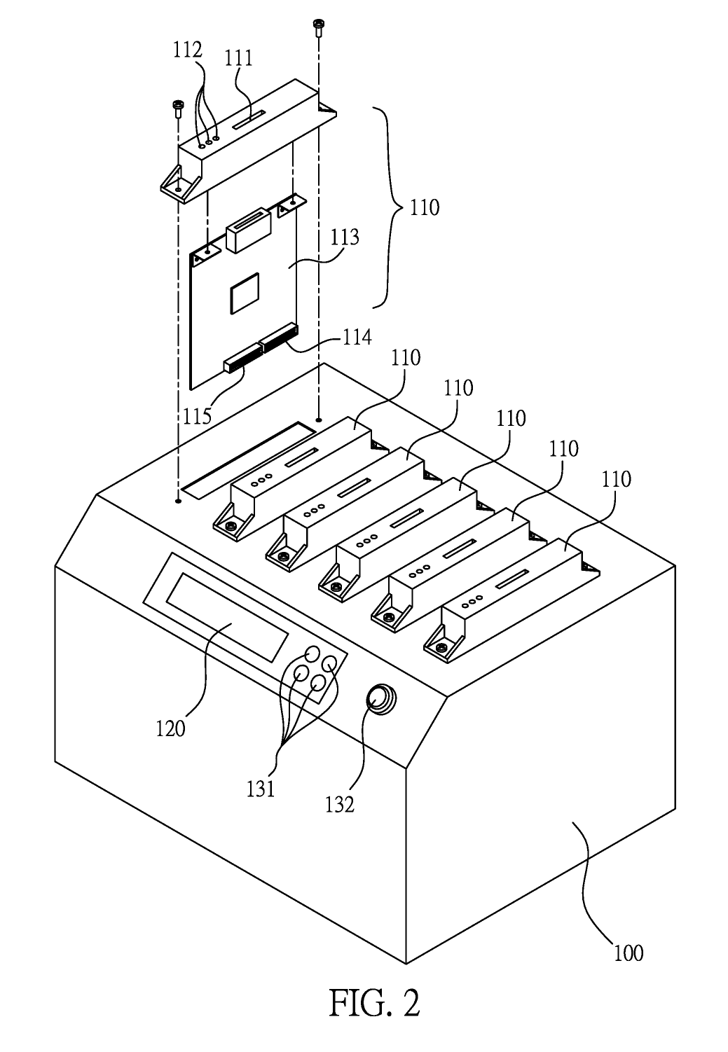

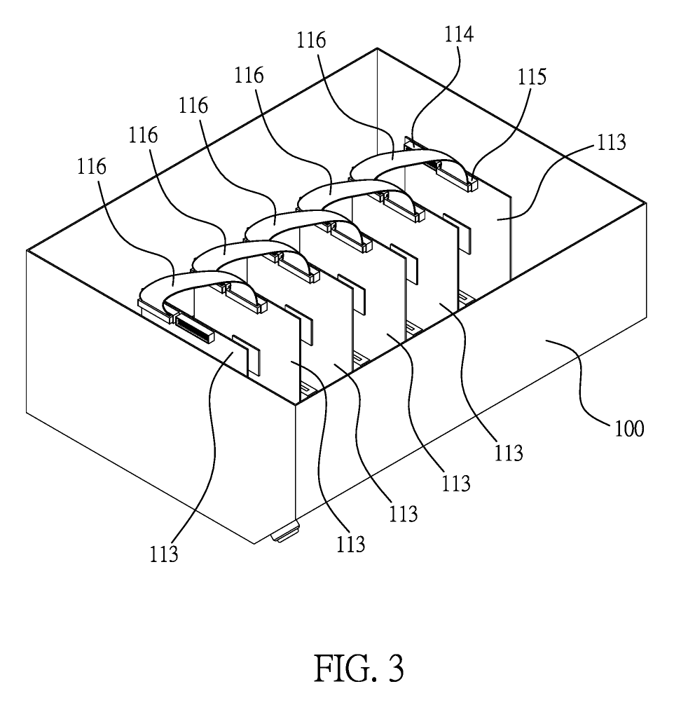

Please refer to FIG. 1, which illustrates an outline of a solid state drive duplication apparatus according to an embodiment of the present invention; FIG. 2, which illustrates an exploded view of a duplication unit of the solid state drive duplication apparatus of FIG. 1; and FIG. 3, which illustrates how duplication units of the solid state drive duplication apparatus of FIG. 1 are interconnected. As illustrated in FIG. 1-3, the solid state drive duplication apparatus includes a case 100, a plurality of duplication units 110, an information display screen 120, and multiple buttons 131-132, wherein each duplication unit 110 has a PCI-E interface 111, a plurality of light indicators 112, a printed circuit board 113, a chain connection input port 114, and a chain connection output port 115, and the duplication units 110 are interconnected one another by a plurality of cables 116 (with each cable 116 connecting the chain connection output port 115 of a duplication unit 110 with the chain connection input port 114 of another duplication unit 110).

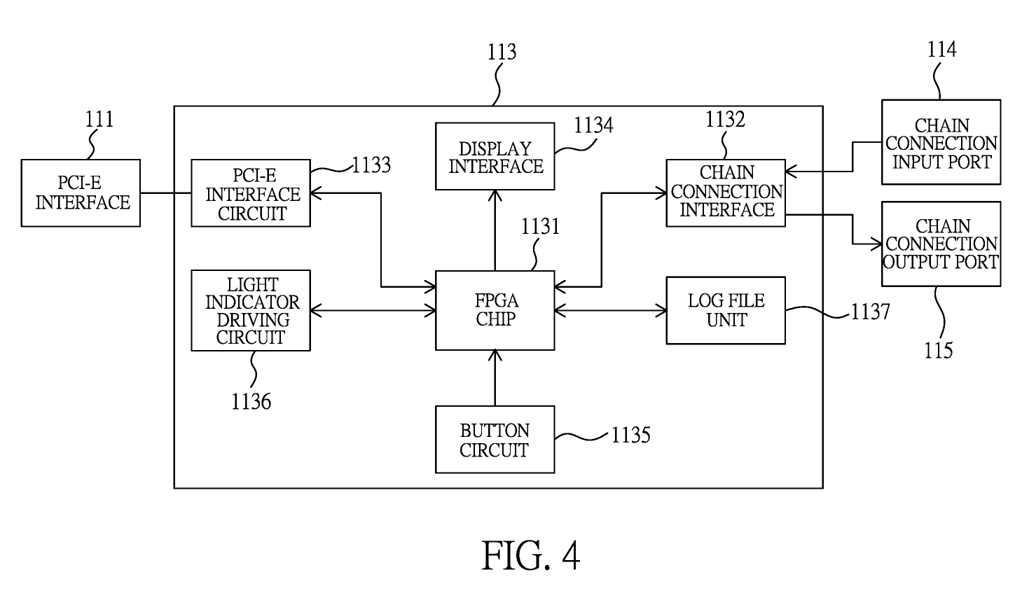

Please refer to FIG. 4, which illustrates a block diagram of a circuit implemented on the printed circuit board 113. As illustrated in FIG. 4, the circuit includes an FPGA chip 1131, a chain connection interface 1132, a PCI-E interface circuit 1133, a display interface 1134, a button circuit 1135, a light indicator driving circuit 1136, and a log file unit 1137, and the chain connection interface 1132 is electrically coupled with the PCI-E interface circuit 1133, the display interface 1134, the button circuit 1135, the light indicator driving circuit 1136, and the log file unit 1137.

The FPGA chip 1131 is electrically coupled with the chain connection input port 114 and the chain connection output port 115 via the chain connection interface 1132, and electrically coupled with the PCI-E interface 111 via the PCI-E interface circuit 1133.

In a first unit of the duplication units 110, the FPGA chip 1131 controls to output source data via the chain connection output port 115; and in each of other units of the duplication units 110, the FPGA chip 1131 controls to receive the source data via the chain connection input port 114 and copy the source data into a solid state drive connected with the PCI-E interface 111, and send out the source data via the chain connection output port 115.

According to the present invention, the source data can be from a source solid state drive connected with the first duplication unit. The source data can also be derived by decompressing an image file from an external computer, where the external computer transmits the image file to the solid state drive duplication apparatus via a USB (universal serial bus) interface (not shown in the figure), or be derived by decompressing a source image file selected from a plurality of image files stored in a storage medium (not shown in the figure) of the solid state drive duplication apparatus.

The FPGA chip 1131 can be coupled with the information display screen 120 (the information display screen 120 can be implemented by a liquid crystal display) via the display interface 1134 for displaying operation information, and coupled with the multiple buttons 131-132 (including a start button and multiple selection buttons) via the button circuit 1135 to receive a user's pressing operations. In one embodiment, only the display interface 1134 and the button circuit 1135 of the first duplication unit are coupled with the information display screen 120 and the multiple buttons 131-132 respectively, while the display interface 1134 and the button circuit 1135 of other duplication units are not used.

The FPGA chip 1131 can drive the light indicators 112 via the light indicator driving circuit 1136 to indicate the operation states of a corresponding duplication unit 110.

Besides, the FPGA chip 1131 can store a log file to the log file unit 1137.

Besides, the solid state drive duplication apparatus can further include at least one PCI-E to SATA converting seat for accommodating at least one SATA solid state drive.

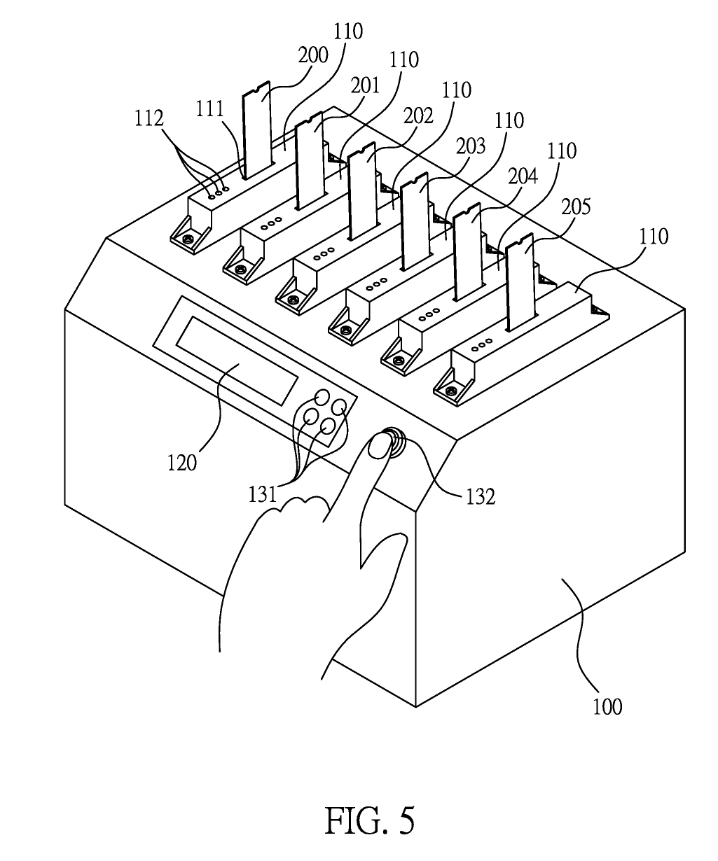

Please refer to FIG. 5, which illustrates an operation scenario of a solid state drive duplication apparatus of the present invention. As illustrated in FIG. 5, by pressing the buttons 131-132 (including a start button and multiple selection buttons), the present invention can copy the source data to solid state drives 200-205, thereby finishing a batch copy operation.

Besides, the solid state drive duplication apparatus of the present invention can further include an extension input port and an extension output port on the case so that the capacity of the batch copy operation can be expanded by connecting the extension output port of one duplication apparatus with the extension input port of another duplication apparatus.

Besides, the solid state drive duplication apparatus of the present invention can also perform a data comparison procedure to ensure the accuracy of data duplication after the batch copy operation.

In addition, as the functions of the present invention can be realized by programming an FPGA chip, therefore, the solid state drive duplication apparatus of the present invention is capable of independently performing the batch copy operation required by users without the need of PC's support. Furthermore, among the various functions (including driving a solid state drive, a display card, an audio card, or an internet card, etc.) that can be provided by the PCI-E interface, as the FPGA chip of the present invention only needs to implement the function of solid state drive duplication, therefore, other functions (such as display card, audio card, internet card, etc. usually provided by a conventional PCI-E controller) can be omitted, and the robustness and reliability of the solid state drive duplication apparatus of the present invention can be greatly improved accordingly.

Thanks to the novel designs disclosed above, the present invention possesses the advantages below:

1. The PCI-E solid state drive duplication apparatus of the present invention uses FPGA chips to implement a PCI-E solid state drive duplication function, so as to independently perform a duplication operation without the need of PC's support, and have the PCI-E solid state drive duplication function implemented in a more simplified way than the way used in a conventional PCI-E controller.

2. The PCI-E solid state drive duplication apparatus of the present invention can expand duplication capacity by chain connection, so as to easily meet different specs requirements of processing different numbers of solid state drives at a time.

3. The source data for duplication operation of the PCI-E solid state drive duplication apparatus of the present invention can be provided by an external computer, or by a solid state drive engaged with a first duplication unit, or by a storage medium of the solid state drive duplication apparatus.

4. The PCI-E solid state drive duplication apparatus of the present invention is implemented with a plurality of independently replaceable duplication units to facilitate fixing local malfunctions of the PCI-E solid state drive duplication apparatus.

5. The PCI-E solid state drive duplication apparatus of the present invention is capable of comparing the contents of a source PCI-E solid state drive with the contents of cloned PCI-E solid state drives to ensure the accuracy of duplication.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A solid state drive duplication apparatus having a plurality of duplication units, each of the duplication units comprising:
a chain connection input port;
a chain connection output port;
a PCI-E interface, and
a printed circuit board, which includes an FPGA chip, a chain connection interface, and a PCI-E interface circuit, the chain connection interface and the PCI-E interface circuit being electrically coupled with the FPGA chip;
wherein the duplication units are interconnected one another in a way that the chain connection output port of one unit of the duplication units is electrically connected with the chain connection input port of another unit of the duplication units; for each unit of the duplication units, the FPGA chip is electrically coupled with the chain connection input port and the chain connection output port via the chain connection interface, and electrically coupled with the PCI-E interface via the PCI-E interface circuit; and in a first unit of the duplication units, the FPGA chip controls to output source data via the chain connection output port; and in each of other units of the duplication units, the FPGA chip controls to receive the source data via the chain connection input port and copy the source data into a solid state drive connected with the PCI-E interface, and send out the source data via the chain connection output port.

2. The solid state drive duplication apparatus of claim 1, wherein the source data is from a source solid state drive connected with the first duplication unit.

3. The solid state drive duplication apparatus of claim 1, wherein the source data is derived by decompressing an image file from an external computer, and the external computer transmits the image file to the solid state drive duplication apparatus via a USB interface.

4. The solid state drive duplication apparatus of claim 1, wherein the source data is derived by decompressing a source image file selected from a plurality of image files stored in a storage medium of the solid state drive duplication apparatus.

5. The solid state drive duplication apparatus of claim 1, wherein the solid state drive duplication apparatus further includes an information display screen coupled with a display interface of the first duplication unit.

6. The solid state drive duplication apparatus of claim 1, further including multiple selection buttons coupled with a button circuit of the first duplication unit.

7. The solid state drive duplication apparatus of claim 1, wherein each of the duplication units further includes a driving circuit for driving multiple light indicators.

8. The solid state drive duplication apparatus of claim 1, further including at least one PCI-E to SATA (serial advanced technology attachment) converting seat for accommodating at least one SATA solid state drive.

9. The solid state drive duplication apparatus of claim 1, further including an extension input port and an extension output port on a case.
